(19) United States
(12) Patent Application Publication
(10) Pub. No.: US 2013/0114296 A1
(43) Pub. Date: May 9, 2013

(54) LIGHT GUIDE APPARATUS AND ELECTRONIC DEVICE USING THE SAME

(71) Applicants: QING-QING ZHENG, Shenzhen City (CN); YONG-HUI HU, Shenzhen City (CN); TIAN-LEI WANG, Shenzhen City (CN); KUN-CHIH HSIEH, Tu-Cheng (TW); KAI-KUEI WU, Tu-Cheng (TW)

(72) Inventors: QING-QING ZHENG, Shenzhen City (CN); YONG-HUI HU, Shenzhen City (CN); TIAN-LEI WANG, Shenzhen City (CN); KUN-CHIH HSIEH, Tu-Cheng (TW); KAI-KUEI WU, Tu-Cheng (TW)

(21) Appl. No.: 13/658,077

(22) Filed: Oct. 23, 2012

(30) Foreign Application Priority Data
Nov. 9, 2011 (CN) 201110351697.3

(51) Int. Cl. F21V 8/00

(52) U.S. Cl. 362/609

(57) ABSTRACT

A light guide apparatus includes a light guide and at least one LED arranged beside the light guide. The light guide includes a first surface and a second surface opposite to the first surface. A scatter layer is attached on the first surface adjacent to the LED and configured to scatter light beams from the at least one LED, a reflective layer is attached on the second surface away from the LED and configured to reflect light beams from the at least one LED to the first surface. The light refracting out from the first surface achieves a homogeneous illumination effect via the diffuse of the scatter layer and the reflection of the reflective layer.

### BACKGROUND

1. Technical Field

The present disclosure relates to a light guide apparatus, especially to a light guide apparatus with uniform illumination and a electronic device employing the light guide apparatus.

2. Description of Related Art

To facilitate the use of electronic devices in the dark or in low light conditions, some electronic devices such as mobile phones are provided with LED backlit icons. Because the LED light sources have a directional characteristic, when needing to illuminate many icons, a light guide is usually used to guide the light beams from the LED light sources such that the icons can be evenly illuminated.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an schematic view of an electronic device in accordance with an exemplary embodiment.

FIG. 2 is a schematic, partial exploded view of the electronic device of FIG. 1.

FIG. 3 is a schematic view showing an light guide apparatus of the electronic device of FIG. 1.

FIG. 4 is a cross-sectional view of the electronic device of FIG. 1, taken along line A-A.

FIG. 5 is a schematic view showing the partial enlarged detail of the encircled portion V of FIG. 1.

FIG. 6 is a schematic view showing the partial enlarged detail of the encircled portion VI of FIG. 1.

FIG. 7 is a schematic view showing the partial enlarged detail of the encircled portion VII of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

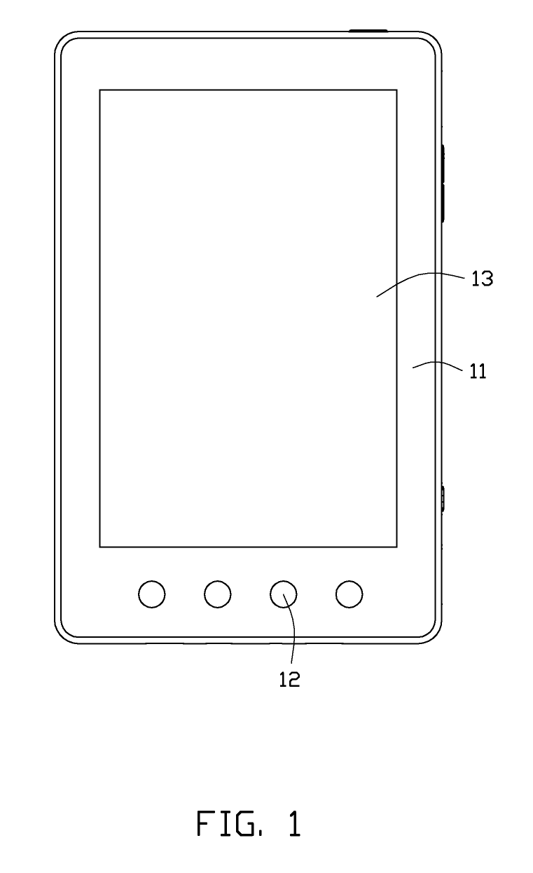

Referring to FIG. 1, an electronic device 100 of one embodiment is shown. The electronic device 100 includes a front frame 11 and a display panel 13 mounted in the front frame 11. The front frame 11 includes a number of icons 12 at the outer surface of the front frame 11. The icon 12 can be a icon displaying on mechanical buttons or touch sensitive buttons, such as resistive type touch sensitive buttons, capacitive type touch sensitive buttons or infrared type touch sensitive buttons. In this embodiment, the icons 12 are light-transmissive, and each of the icons 12 includes a transparent pattern. In other embodiments, the icons 12 may be transparent, translucent or other photic icons.

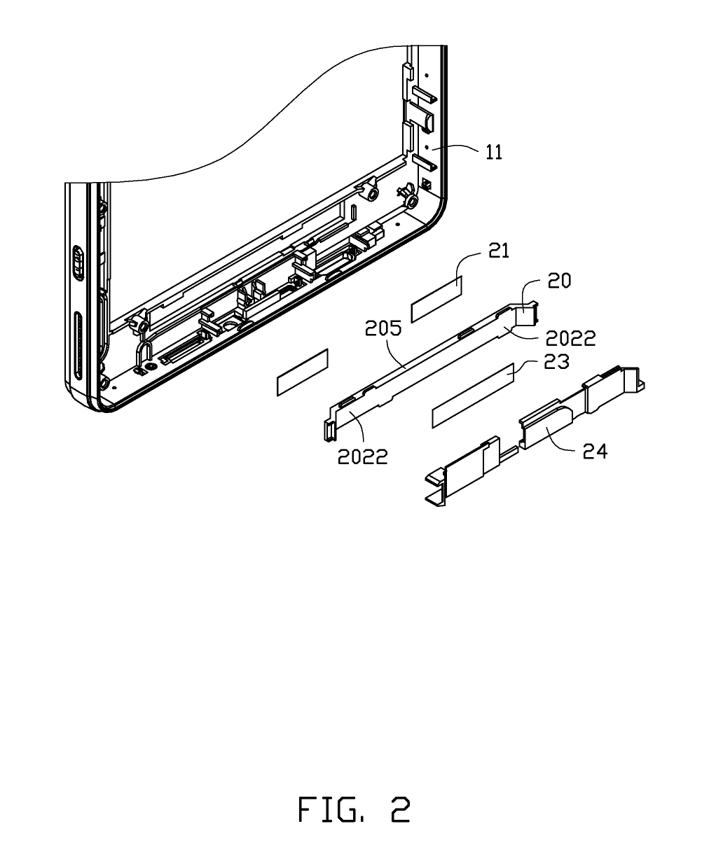

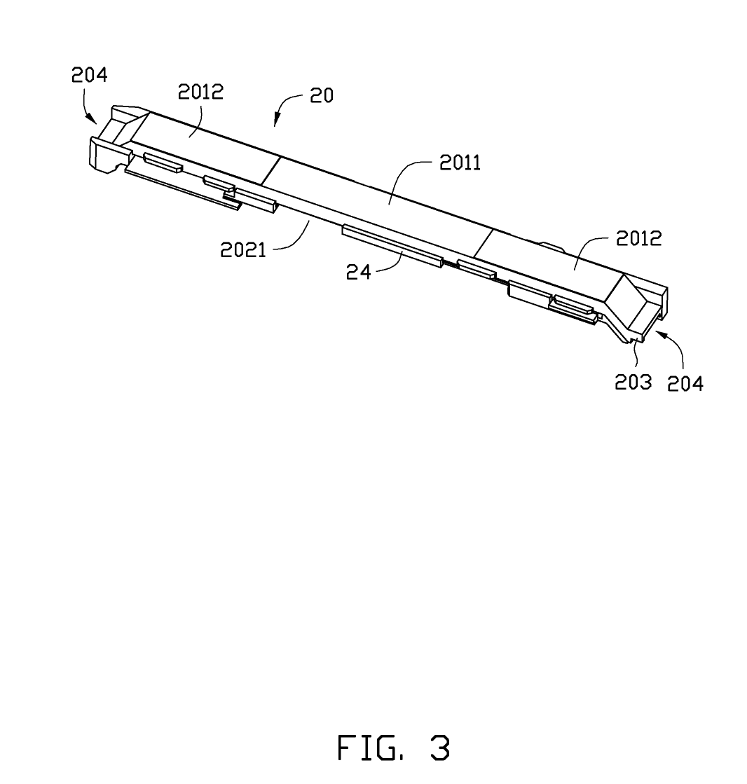

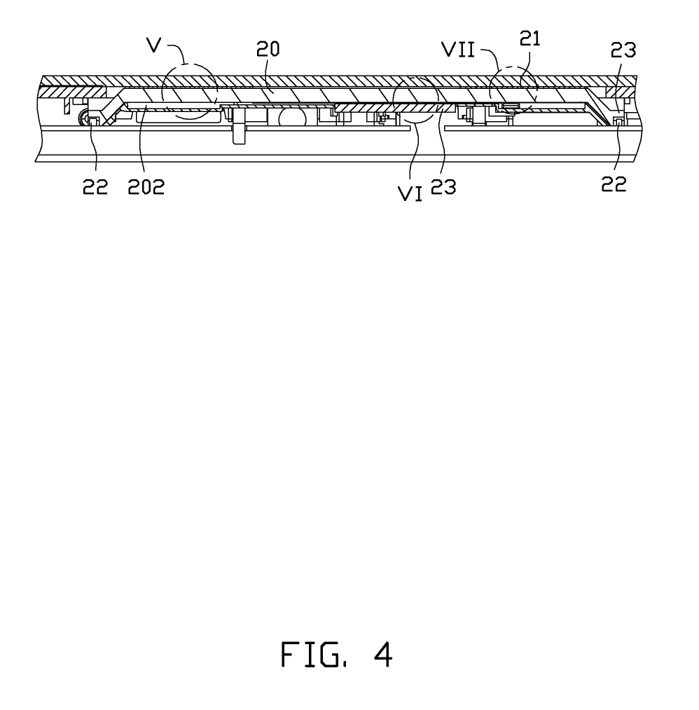

Referring to FIGS. 2-4, the electronic device 100 further includes a light guide apparatus 200 arranged on the inner side of the frame 11 behind the icons 12. The light guide apparatus 200 includes an elongated light guide member 20, at least one light sources 22 arranged beside the light guide member 20, and a shielding member 24. In this embodiment, there are two LEDs 22 arranged on the opposite ends of the light guide member 20. The light guide member 20 includes a straight intermediate portion 205 and two bent portions 204 respectively obliquely connected to opposite ends of the intermediate portion 205. The icons 12 are aligned along the straight intermediate portion 205 of the light guide member 20. A recess 203 is defined in each end of the bent portion 204 for accommodating the light source 22. Two light sources 22 are optically coupled to distal ends of the bent portions 205, respectively, and oriented along a same direction.

The light intermediate portion 205 includes a first surface 201 and a second surface 202 opposite to the first surface 201. The light beams enter the light guide member 20 from the opposite ends of the light guide member 20 and refract out of the light guide member 20 through the first surface 201. The light beams refracting out of the light guide member 20 pass through the transparent pattern of each button 12, thus allowing a user to recognize the icons 12 according to their respective glowing pattern in the dark or in low light conditions. The first surface 201 includes an intermediate exposed portion 2011 and two outer portions 2012 located on opposite sides of the exposed portion 2011, the second surface 202 includes an intermediate portion 2021 and two outer portions 2022 located on opposite sides of the intermediate portion 2021.

The shielding member 24 is located behind the light guide member 20 and covers the second surface 202 and the other lateral surfaces of the light guide member 20. The shielding member 24 in the embodiment is made of rubber.

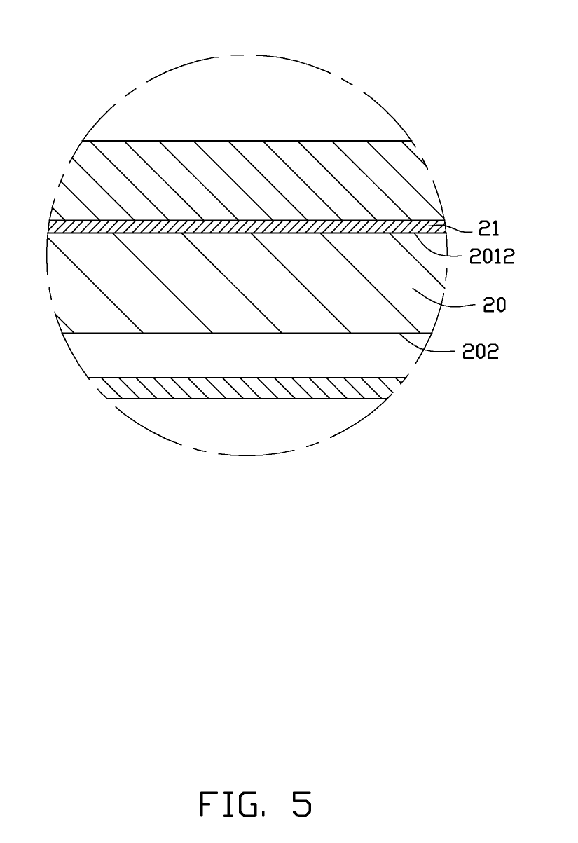

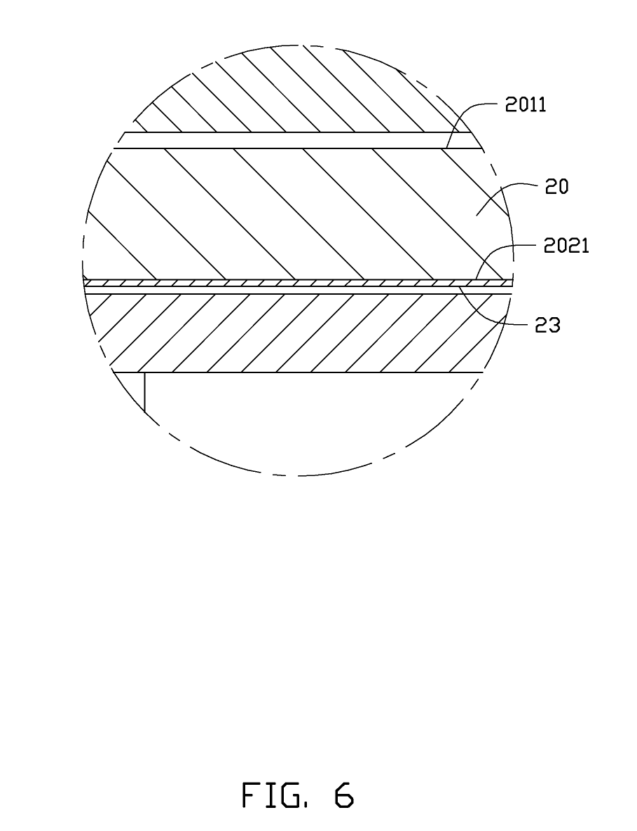

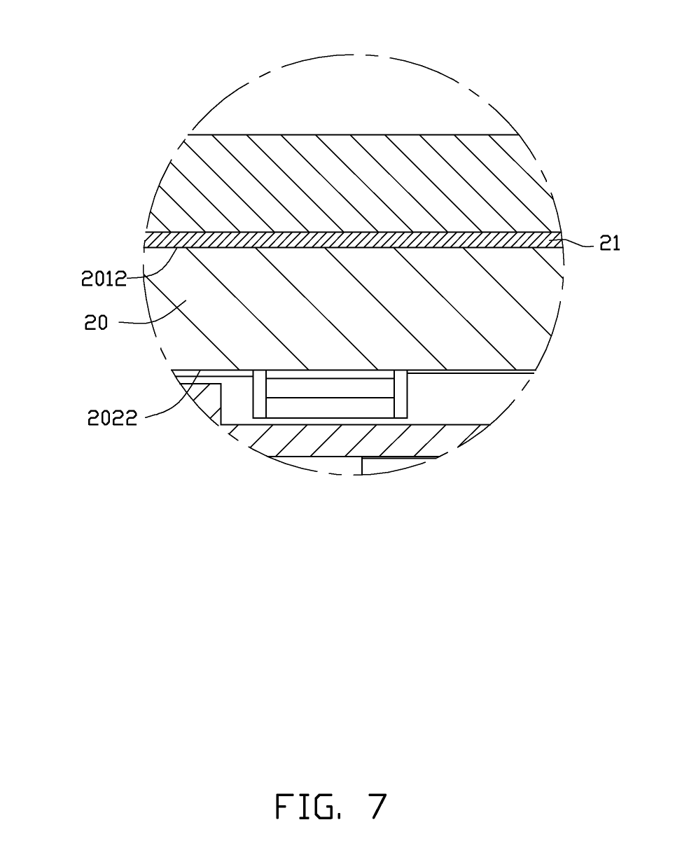

FIGS. 5-7 shows the light guide apparatus 200 of the embodiment. The light guide apparatus 200 further includes two spaced scatter layers 21 respectively attached on the outer portions 2012 of the first surface 201, and a reflective layer 23 attached on an intermediate portion 2021 of the second surface 202 with the outer portions 2022 of the second surface 202 free of reflective layer 23 thereon. In this embodiment, the scatter layer 21 includes two pieces of diffuser membrane arranged on the regions of the first surface 201 near the two ends adjacent to the LED 22, and the reflective layer 23 is a reflective membrane arranged on the middle of the second surface 202.

If there is no scatter layer 21 and reflective layer 23, because the two LEDs 22 are respectively arranged at the two ends of the light guide member 20, the regions near the two ends of light guide member 20 are brighter than the middle region of the light guide member 20.

In the embodiment, the light beams reaching the scatter layer 21 are scattered. That is, some of the light beams travel out from the scatter layer 21, and some of the light beams are reflected and continue to travel in the light guide member 20. As a result, the light beams refracting out from the regions of first surface 201 adjacent to the LED 22 is reduced as compared to when there is no scatter layer 21 arranged on the first surface 201. The reflective layer 23 reflects the light beams reaching the second surface 202 to the middle region of the first surface 201, such that more light beams refract out from the middle region of the first surface 201 as compared to when there is no reflective layer 23 arranged on the second surface 202. The light guide member 20 can then give out substantially homogeneous light beams. The brightness of the icons 12 is substantially the same.

In another embodiment, the light guide apparatus 200 may only include one LED 22 arranged at one end of the light guide member 20. The scatter layer 21 may be a diffuser membrane covering the half of the first surface 201 adjacent to the LED 22, and the reflective layer 23 may be a reflective membrane covering the half of the second surface 202 away from the LED 22. In other embodiments, the LED 22 can be located at any position beside the light guide member 20, the position and the area of the scatter layer 21 and the reflective layer 23 can be arranged accordingly.

It is to be understood, however, that even though numerous characteristics and advantages of the present disclosure have been set forth in the foregoing description, together with details of the structure and function of the present disclosure, the present disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A light guide apparatus comprising:
an elongated light guide member comprising a straight intermediate portion and two bent portions respectively obliquely connected to opposite ends of the intermediate portion, the intermediate portion including a first surface and a second surface opposite to the first surface, the first surface including an intermediate exposed portion and two outer portions located on opposite sides of the exposed portion, the second surface including an intermediate portion and two outer portions located on opposite sides of the intermediate portion;
two light sources optically coupled to distal ends of the bent portions, respectively
two spaced light scattering layer respectively attached on the outer portions of the first surface; and
a reflective layer attached on an intermediate portion of the second surface with the outer portions of the second surface free of reflective layer thereon.

2. The light guide apparatus of claim 1, wherein the light sources are oriented along a same direction.

3. A light guide apparatus comprising:
an elongated light guide member comprising a first surface and a second surface opposite to the first surface;
two light emitting diodes (LEDs) optically coupled to opposite ends of the light guide member;
two spaced light scattering layers respectively arranged on end regions of the first surface adjacent to the respective LEDs; and
a reflective layer arranged on the second surface.

4. The light guide apparatus of claim 3, further comprising a shielding member configured to cover the second surface.

5. The light guide apparatus of claim 4, wherein the shielding member is made of rubber.

6. The light guide apparatus of claim 3, wherein a recess is defined in each end of the light guide to receive the corresponding LED therein.

7. An electronic device comprising:
an elongated light guide member comprising a straight intermediate portion and two bent portions respectively obliquely connected to opposite ends of the intermediate portion, the intermediate portion including a first surface and a second surface opposite to the first surface, the first surface including an intermediate exposed portion and two outer portions located on opposite sides of the exposed portion, the second surface including an intermediate portion and two outer portions located on opposite sides of the intermediate portion;
two light sources optically coupled to distal ends of the bent portions, respectively
two spaced light scattering layer respectively attached on the outer portions the first surface; and
a reflective layer attached on an intermediate portion of the second surface with the outer portions of the second surface free of reflective layer thereon
a front panel covering the light guide member, the front panel comprising a plurality of icons aligned along the straight intermediate portion of the light guide member, the light guide member configured for receiving light from the light sources and emitting the light through the first surface to illuminate the icons.

8. The electronic device of claim 7, further comprising a shielding member configured to cover the second surface.

9. The electronic device of claim 8, wherein the shielding member is made of rubber.

10. The electronic device of claim 7, wherein a recess is defined in each distal end to receive the corresponding LED.
